(19) United States
(12) Patent Application Publication
(10) Pub. No.: US 2007/0275770 A1
(43) Pub. Date: Nov. 29, 2007

(54) Hands-free accessory for mobile telephone

(75) Inventor: Edward Craig Hyatt, Durham, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/440,879

(22) Filed: May 25, 2006

(51) Int. Cl. H04M 1/00

(52) U.S. Cl. 455/569.2

(57) ABSTRACT

A hands-free unit mounts to the sun visor in a vehicle and communicates with a remote hands-free unit. The hands-free unit includes a solar panel that is pivotally attached to a hands-free unit. The solar panel moves between a storage position in which the solar panel lies flat against the hands-free unit, and a deployed position in which the solar panel is pivoted away from the hands-free unit. A biasing mechanism urges the solar panel to the deployed position. A latch mechanism can be provided to hold the solar panel in the storage position when the hands-free unit is not being used in a vehicle.

### BACKGROUND

The present invention relates generally to mobile communication devices, and more particularly, to a hands-free accessory for a mobile communication device for use in a vehicle.

It is estimated that over 200 million people in the United States have used mobile telephones. The prevalence of mobile telephones has led to a rise in the number of people who use mobile telephones while driving. Driver inattention is the main cause of vehicle accidents and mobile telephones have been identified as a major cause of driver distraction. When using a mobile telephone, the driver of a vehicle must typically take their eyes off the road while dialing the mobile telephone. For this reason, the use of handheld mobile telephones has been banned in many states.

Numerous hands-free accessories for mobile telephones have been developed that allow a driver of a vehicle to more easily place or answer calls. For example, some hands-free units mount on the sun visor of a vehicle. The hands-free unit typically includes a microphone and speaker that enable the driver to engage in conversation without the need to hold a handheld mobile telephone. The hands-free unit typically includes simple controls that can be easily manipulated by the user without the driver taking their eyes off the road. Modern hands-free units typically include a short range interface, such as a Bluetooth interface, that enables the hands-free unit to communicate with the user's mobile telephone. When the mobile telephone is “paired” with the hands-free unit, signals are transmitted between the mobile telephone and hands-free unit.

Power for the hands-free unit is typically provided by internal batteries in the hands-free unit. Alternatively, the hands-free unit may include a power cord for connecting the hands-free unit to a power source in the vehicle. Neither of these approaches is entirely satisfactory. The main problem with batteries is the need for frequent replacement and/or recharging. The alternative approach avoids this problem, but the user must tolerate a cord dangling from the hands-free unit.

### SUMMARY

The present invention provides a method and apparatus for providing power to a hands-free unit that is mounted to the sun visor of a vehicle. A solar panel provides power for the hands-free unit and is pivotally connected to the hands-free unit by a hinge mechanism. The solar panel is movable from a storage position in which the solar panel lies flat against a surface of the hands-free unit, and a deployed position in which the solar panel is pivoted away from the surface of the hands-free unit. The hinge mechanism may include a biasing member, such as a spring, to bias the solar panel to the deployed position. A latch mechanism may be provided to retain the solar panel in the storage position when the hands-free device is not in use, or when it is being used as a desk unit. Additionally, a dampening mechanism may be provided to prevent the solar panel from opening too fast and causing damage to the unit.

### BRIEF DESCRIPTION OF THE DRAWINGS

FIG. 1 is a functional block diagram showing the main components of the hands-free unit.

FIG. 2 is a perspective view of an exemplary hands-free unit according to one exemplary embodiment with a solar panel in a closed position.

FIG. 3 is a perspective view of the hands-free unit with the solar panel in a deployed position.

FIG. 4 is an exploded perspective view of the hands-free unit illustrating the hinge mechanism.

FIG. 5 is a schematic diagram illustrating the hands-free unit mounted in a vehicle.

### DETAILED DESCRIPTION

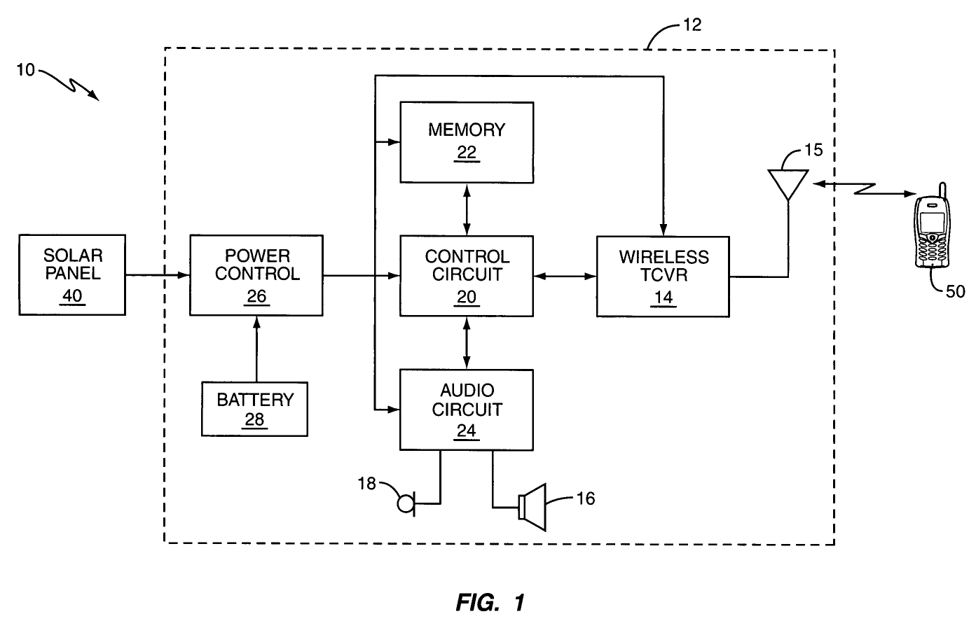

FIG. 1 illustrates the main functional elements of an exemplary hands-free accessory indicated generally by the numeral 10 for use with a mobile communication device 50 such as a mobile telephone. The hands-free accessory 10 includes a hands-free unit 12 and a solar panel 40 pivotally connected to the hands-free unit 12 as will be hereinafter described. The hands-free unit 12 includes a wireless interface 14 for communicating with the mobile communication device 50. The wireless interface 14 may comprise a short-range radio interface such as a BLUETOOTH or WiFi interface coupled to an antenna 15, or may comprise an infrared interface. Voice and audio signals received by the mobile communication device 50 are transmitted to the hands-free unit 10 and output to a speaker 16 on the hands-free unit 10. In the reverse direction, audible sounds picked up by a microphone 18 on the hands-free unit 10 are transmitted via the wireless interface 14 to the mobile communication device 60. The solar panel 40 provides energy to power the hands-free unit 10, and/or to recharge batteries 28 of the hands-free unit 12.

The hands-free unit 12 includes a control circuit 20 to control operation of the hands-free unit 12, a memory 22 to store data and programs needed for operation, an audio circuit 24 to process audio signals, and a power control circuit 26. The control circuit 20 may comprise one or more processors, hardware, firmware or a combination thereof. Memory 22 may comprise one or more discrete memory devices, internal memory, or a combination thereof. Programs needed for operation are stored in a permanent memory, such as EEPROM or flash memory. Audio circuit 24 processes audio signals output to speaker 16 and input via microphone 18. Power control circuit 26 provides power for the hands-free unit 12, which may be derived from battery 28 and/or solar panel 40.

In one exemplary embodiment, the battery 28 serves as the primary source of power and the solar panel 40 provides energy for recharging the batteries 28. The power control circuit 26 may also detect low battery power and initiate charging. In other embodiments of the invention, the solar panel 40 may be configured as the primary power source. In this case, the battery 28 may provide back-up power when there is insufficient sunlight to power the hands-free unit 12. The power control circuit 26 may automatically switch between the solar panel 40 and battery 28 when it detects that the solar panel 40 is not producing sufficient energy.

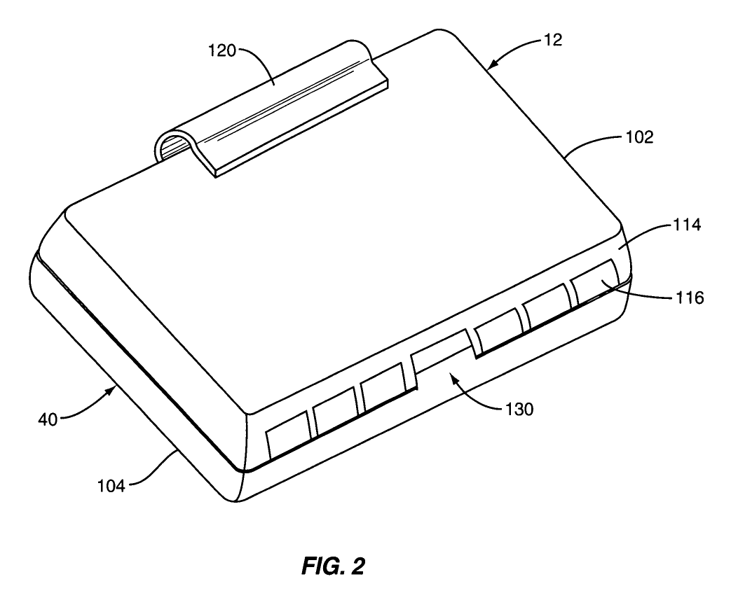

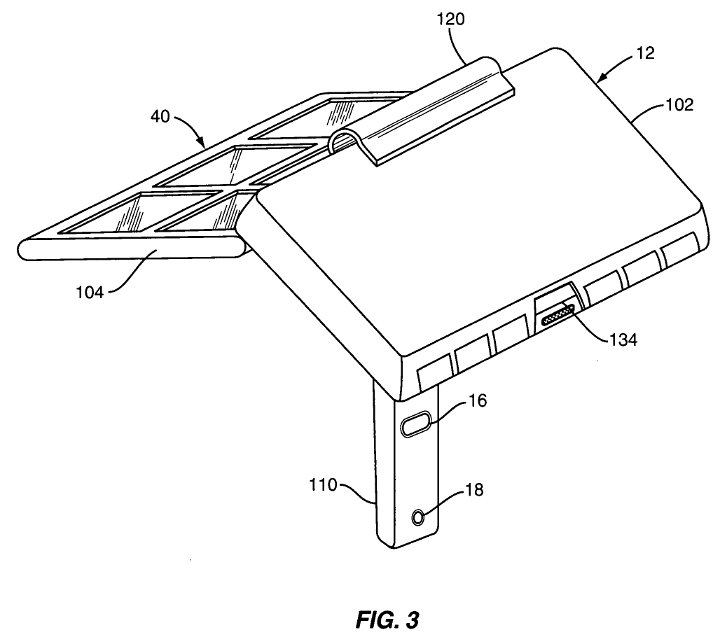

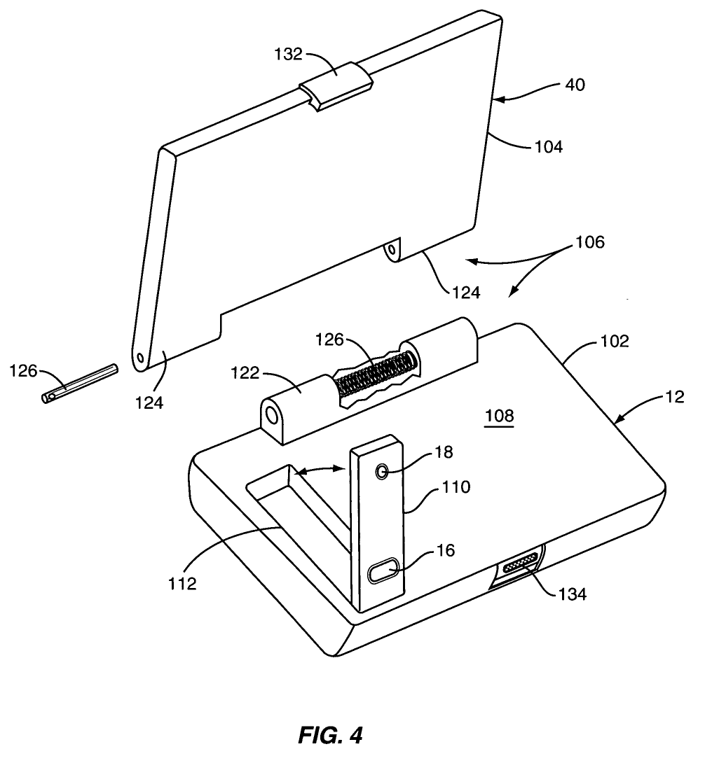

FIGS. 2 through 4 illustrate an exemplary physical implementation of the hands-free accessory 10. The hands-free unit 12 includes a housing 102 that encloses the electrical components of the hands-free unit 12. Similarly, solar panel 40 includes a housing 104 to provide protection for the solar panel 40. Hinge mechanism 106, best seen in FIG. 4, pivotally connects the hands-free unit 12 and solar panel 40. Hinge mechanism 106 enables the solar panel 40 to pivot relative to hands-free unit 12 between a storage position shown in FIG. 2 and a deployed position shown in FIG. 3. In the storage position, solar panel 40 lies flat against a bottom surface 108 of the hands-free unit 12. In the deployed position, the solar panel 34 is pivoted away from the bottom surface 108 of the hands-free unit 12.

A boom 110 containing the speaker 16 and microphone 18 is pivotally mounted to the housing section 102. The boom 110 is also movable between a deployed position shown in FIG. 2, and a storage position (not shown) in which the boom 108 rotates into a recessed area 112 in housing 102 of the hands-free unit 12.

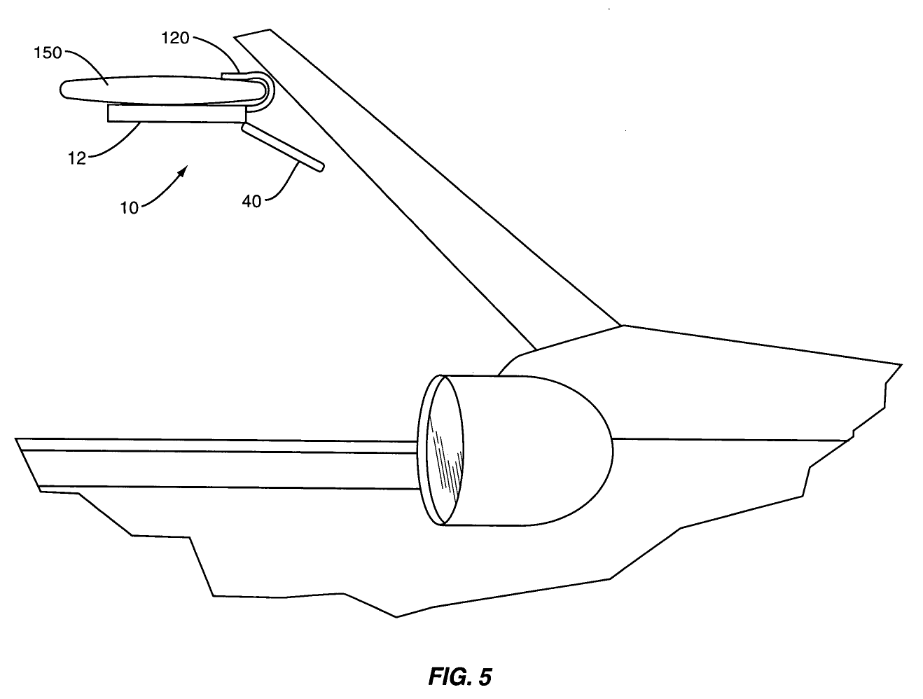

A mounting clip 120 is connected to the housing 102 of the hands-free unit 12. Mounting clip 120 is used to mount the hands-free unit 12 to the sun visor 150 of a vehicle as shown in FIG. 5. The mounting clip 120 may be made from a resilient material, such as rubber-coated spring steel. In the disclosed embodiment, the mounting clip 120 is designed to engage the top edge of the sun visor 150. Those skilled in the art will appreciate, however, that the mounting clip 120 could also be configured and arranged to engage the bottom edge of the sun visor 150. Also, other mechanisms could be used to mount the hands-free accessory 10 to the sun visor 150. For example, straps that extend around the sun visor 150 may be used for mounting the hands-free accessory 10 to the sun visor 150.

The front face 114 of housing 102 of the hands-free unit 12 includes one or more control buttons 116. The control buttons 116 provide input to the control circuit 20 and are used to perform communication functions, such as initiating a call, answering a call, terminating a call, placing a call on hold, etc. The control buttons 116 are arranged to be easily accessible to the driver without the driver having to take their eyes off the road. After a call is initiated by pressing the appropriate control button 116, the driver may provide the number to be dialed by voice commands.

FIG. 4 illustrates details of the hinge mechanism 106. The hinge mechanism 106 comprises a first hinge section 122 integrally formed with housing 102, and second hinge section 124 integrally formed with housing 104. A hinge shaft 126 extends through the first and second hinge sections 122, 124. Hinge section 122 on the hands-free unit 12 contains a torsion spring 126 or similar mechanism to provide a biasing force to bias housing section 104 to a deployed position. The torsion spring 126 applies a force that pivots the solar panel 40 to a deployed position. The hinge mechanism 106 may include a detent mechanism for positioning the solar panel 40 in the deployed position. The hinge mechanism 106 may further include a dampening mechanism to prevent the solar panel 40 from opening too fast. Because spring biased hinge mechanisms are well known in the art, further description of the same is omitted.

A latch mechanism 130 may be provided to secure the solar panel 40 in the storage position. One exemplary latch mechanism 130 includes a first latch component 132 connected to the solar panel 40 and a second latch component 134 on the hands-free unit 12. The first latch component includes a catch element. The second latch component comprises a button on the hands-free unit 12. The first and second latch components are adapted to engage when the solar panel 40 is in the storage position. The second latch component 134 is spring-biased to maintain engagement with the first latch component 120. The latch mechanism 130 is released by pressing the second latch component 134 to disengage the first and second latch components 132, 134.

FIG. 5 illustrates the hands-free accessory 10 as it would be used in a vehicle. As shown in FIG. 5, the hands-free accessory 10 is mounted to the sun visor 150 in the vehicle by engaging the mounting clip 112 with the top edge of the sun visor 150. After mounting to the sun visor 150, the latch mechanism can be pressed to release the housing section 104. When the latch mechanism is released, the torsion spring 126 applies force that urges the housing section 104 away from housing section 102. Housing section 104 will continue to open until the limits of the torsion spring 126 are reached, or until the housing section 104 contacts the windshield of the vehicle. It should be noted that when the sun visor 150 is lowered while driving, housing section 104 will move back towards housing section 102. When the sun visor 150 is raised again, the torsion spring 106 will automatically return the housing section 104 to the deployed position. Thus, the housing section 104 does not need to be repositioned each time the sun visor 150 is raised or lowered.

While designed for use in a vehicle, the hands-free accessory 10 could also be used as a desk phone. That is, when the solar panel 40 is in the storage position, the hands-free accessory has a form factor that is suitable for desktop use.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A communication device for use in a vehicle, said communication device comprising:
a. a hands-free unit adapted to be mounted in a vehicle, said hands-free unit including a communication circuit for communicating with a remote unit;
b. a solar panel providing power for the hands-free unit; and
c. a hinge mechanism pivotally connecting the solar panel to the hands-free unit so as to be movable between a storage position in which the solar panel lies flat against a surface of the hands-free unit and a deployed position in which the solar panel is pivoted away from the surface of said hands-free unit; and
d. a mounting device for mounting the hands-free unit in said vehicle.

2. The communication device of claim 1 wherein said hinge mechanism includes a biasing member to bias said solar panel to a deployed position.

3. The communication device of claim 2 wherein said biasing member comprises a spring.

4. The communication device of claim 3 further comprising a latch mechanism to secure the solar panel in the storage position.

5. The communication device of claim 1 wherein the mounting device comprises a resilient clip that engages an edge of the sun visor in a vehicle.

6. The communication device of claim 1 wherein said hinge mechanism further comprises a dampening mechanism to apply a frictional force to the hinge mechanism.

7. The communication device of claim 1 wherein said hinge mechanism further includes a detent engaging the solar panel in the deployed position.

8. A communication device for use in a vehicle, said communication comprising:
a. a hands-free unit adapted to be mounted in a vehicle, said hands-free unit including a communication circuit for communicating with a remote unit, a speaker for outputting audible signals, and a microphone for detecting audible signals;
b. a solar panel providing power for the hands-free unit;
c. a hinge mechanism pivotally connecting the solar panel to the hands-free unit so as to be movable between a storage position in which the solar panel lies flat against a surface of the hands-free unit and a deployed position in which the solar panel is pivoted away from the surface of said hands-free unit; and
d. a mounting device for mounting the hands-free unit to said sun visor.

9. The communication device of claim 8 wherein said hinge mechanism includes a biasing member to bias said solar panel to a deployed position.

10. The communication device of claim 9 wherein said biasing member comprises a spring.

11. The communication device of claim 10 further comprising a latch mechanism to secure the solar panel in the storage position.

12. The communication device of claim 8 wherein the mounting device comprises a resilient clip that engages an edge of the sun visor.

13. The communication device of claim 8 wherein said hinge mechanism further comprises a detent mechanism to apply a frictional force to the hinge mechanism.

14. The communication device of claim 8 wherein said hinge mechanism further includes a detent engaging the solar panel in the deployed position.
